(19) United States
(12) Patent Application Publication
(10) Pub. No.: US 2020/0079371 A1
(43) Pub. Date: Mar. 12, 2020

(54) PREDICTION APPARATUS, VEHICLE, PREDICTION METHOD, AND COMPUTER-READABLE STORAGE MEDIUM

(71) Applicant: HONDA MOTOR CO., LTD., Tokyo (JP)

(72) Inventors: Yosuke SAKAMOTO, Wako-shi (JP); Masamitsu TSUCHIYA, Wako-shi (JP); Kazuma OHARA, Wako-shi (JP)

(21) Appl. No.: 16/685,049

(22) Filed: Nov. 15, 2019

Related U.S. Application Data
(63) Continuation of application No. PCT/JP2017/020549, filed on Jun. 2, 2017.

(51) Int. Cl. B60W 30/095; B60W 40/04; G06K 9/00

(52) U.S. Cl. CPC B60W 30/0956; B60W 40/04; G06K 9/00825; B60W 2550/22; G06K 9/00362; B60W 2550/30; G06K 9/00335

(57) ABSTRACT

A prediction apparatus comprising acquisition means for acquiring information of another vehicle existing on the periphery of a self-vehicle and information of an object existing on the periphery of the other vehicle, and prediction means for predicting a behavior of the other vehicle based on the information of the other vehicle and the information of the object acquired by the acquisition means.

### CROSS-REFERENCE TO RELATED APPLICATION

This application is a continuation of International Patent Application No. PCT/JP2017/020549 filed on Jun. 2, 2017, the entire disclosure of which is incorporated herein by reference.

### TECHNICAL FIELD

The present invention mainly relates to a prediction apparatus for a vehicle.

### BACKGROUND ART

PTL 1 describes that when another vehicle such as a bus is traveling on the periphery of a self-vehicle, it is determined whether a bus stop exists on the scheduled traveling route of the self-vehicle, thereby predicting that there is a possibility that the other vehicle stops near the self-vehicle.

### CITATION LIST

### Patent Literature

PTL 1: Japanese Patent Laid-Open No. 2010-39717

### SUMMARY OF INVENTION

### Technical Problem

There is a demand for the prediction, when driving, of the behavior of another vehicle at a higher accuracy to implement safe driving.

It is an object of the present invention to raise the accuracy of behavior prediction of another vehicle on a road.

### Solution to Problem

According to the present invention, there is provided a prediction apparatus comprising an acquisition unit for acquiring information of another vehicle existing on the periphery of a self-vehicle and information of an object existing on the periphery of the other vehicle, and a prediction unit for predicting a behavior of the other vehicle based on the information of the other vehicle and the information of the object acquired by the acquisition unit, wherein if a person is confirmed as the object, and it is confirmed that the person turns eyes to a side of the other vehicle, the prediction unit predicts that the other vehicle will decelerate.

### Advantageous Effects of Invention

According to the present invention, it is possible to raise the accuracy of behavior prediction of another vehicle on a road.

### BRIEF DESCRIPTION OF DRAWINGS

FIG. 1 is a view for explaining an example of the arrangement of a vehicle;

FIG. 2 is a plan view for explaining an example of the arrangement position of a detection unit;

FIG. 3 is a view for explaining an example of a method of setting a warning region for each object on a road;

FIGS. 4A, 4B, and 4C are plan views for explaining an example of a behavior prediction method in a case in which a preceding vehicle is a taxi;

FIGS. 5A and 5B are flowcharts for explaining an example of the prediction method of a prediction ECU; and

FIG. 6 is a plan view for explaining an example of a method of predicting the behavior of another vehicle on an opposite lane.

### DESCRIPTION OF EMBODIMENTS

Embodiments of the present invention will now be described with reference to the accompanying drawings. Note that the drawings are schematic views showing structures or arrangements according to the embodiments, and the dimensions of members shown in the drawings do not necessarily reflect the actuality. In addition, the same members or the same constituent elements are denoted by the same reference numerals in the drawings, and a description of repetitive contents will be omitted below.

### First Embodiment

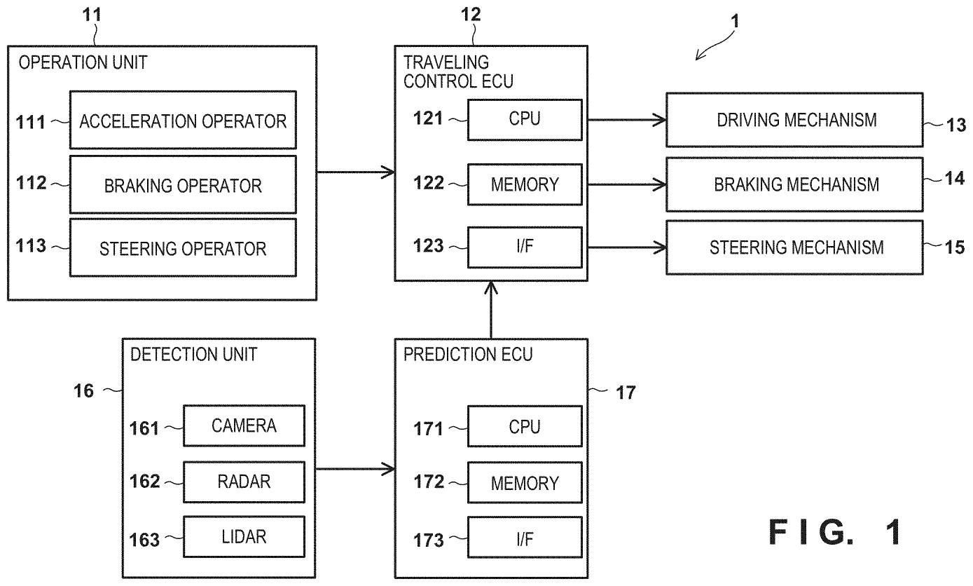

FIG. 1 is a block diagram for explaining the arrangement of a vehicle 1 according to the first embodiment. The vehicle 1 includes an operation unit 11, a traveling operation ECU (Electronic Control Unit) 12, a driving mechanism 13, a braking mechanism 14, a steering mechanism 15, a detection unit 16, and a prediction ECU 17. Note that in this embodiment, the vehicle 1 is a four-wheeled vehicle. However, the number of wheels is not limited to four.

The operation unit 11 includes an acceleration operator 111, a braking operator 112, and a steering operator 113. Typically, the acceleration operator 111 is an accelerator pedal, the braking operator 112 is a brake pedal, and the steering operator 113 is a steering wheel. These operators 111 to 113 may use operators of another type such as a lever type or button type.

The traveling operation ECU 12 includes a CPU 121, a memory 122, and a communication interface 123. The CPU 121 performs predetermined processing based on an electric signal received from the operation unit 11 via the communication interface 123. The CPU 121 stores the processing result in the memory 122 or outputs it to the mechanisms 13 to 15 via the communication interface 123. With this arrangement, the traveling operation ECU 12 controls the mechanisms 13 to 15.

The traveling operation ECU 12 is not limited to this arrangement, and a semiconductor device such as an ASIC (Application Specific Integrated Circuit) may be used as another embodiment. That is, the function of the traveling operation ECU 12 can be implemented by either hardware or software. In addition, the traveling operation ECU 12 has been described here as a single element to facilitate the explanation. However, this may be divided into a plurality of ECUs. The traveling operation ECU 12 may be divided into, for example, three ECUs for acceleration, braking, and steering.

The driving mechanism 13 includes, for example, an internal combustion engine and a transmission. The braking mechanism 14 is, for example, a disc brake provided on each wheel. The steering mechanism 15 includes, for example, a power steering. The traveling operation ECU 12 controls the driving mechanism 13 based on the operation amount of the acceleration operator 111 by the driver. In addition, the traveling operation ECU 12 controls the braking mechanism 14 based on the operation amount of the braking operator 112 by the driver. Furthermore, the traveling operation ECU 12 controls the steering mechanism 15 based on the operation amount of the steering operator 113 by the driver.

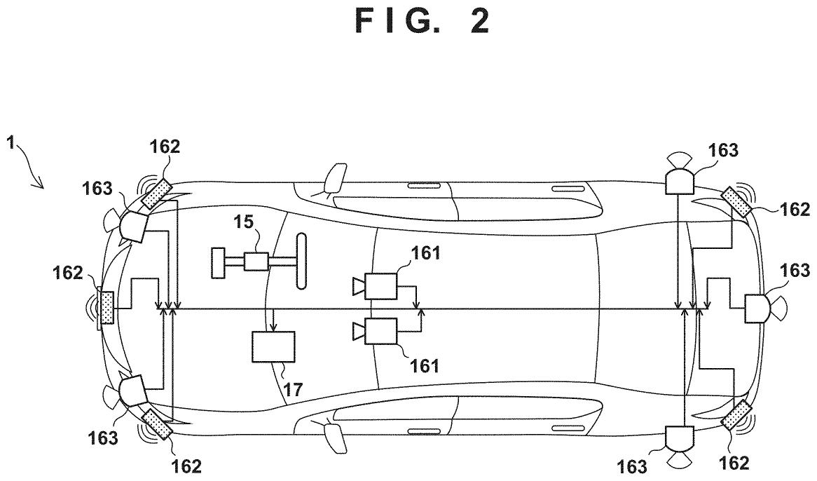

The detection unit 16 includes a camera 161, a radar 162, and a LiDAR (Light Detection and Ranging) 163. The camera 161 is, for example, an image capturing apparatus using a CCD/CMOS image sensor. The radar 162 is, for example, a distance measuring apparatus such as a millimeter-wave radar. The LiDAR 163 is, for example, a distance measuring apparatus such as a laser radar. These apparatuses are arranged at positions where peripheral information of the vehicle 1 can be detected, for example, on the front side, rear side, upper side, and lateral sides of the vehicle body, as shown in FIG. 2.

Here, in this specification, expressions “front”, “rear”, “upper”, and “lateral (left/right)” are used in some cases. These are used as expressions representing relative directions with respect to the vehicle body. For example, “front” represents the front side in the longitudinal direction of the vehicle body, and “upper” represents the height direction of the vehicle body.

The vehicle 1 can perform automated driving based on a detection result (peripheral information of the vehicle 1) of the detection unit 16. In this specification, automated driving means partially or wholly performing the driving operation (acceleration, braking, and steering) not on the driver side but on the side of the traveling operation ECU 12. That is, the concept of automated driving includes a form (so-called full automated driving) in which the driving operation is wholly performed on the side of the traveling operation ECU 12 and a form (so-called driving support) in which part of the driving operation is performed on the side of the traveling operation ECU 12. Examples of driving support are a vehicle speed control (automatic cruise control) function, a following distance control (adaptive cruise control) function, a lane departure prevention support (lane keep assist) function, a collision avoidance support function, and the like.

The prediction ECU 17 predicts the behavior of each object on a road, as will be described later in detail. The prediction ECU 17 may be referred to as a prediction apparatus, a behavior prediction apparatus, or the like, or may be referred to as a processing apparatus (processor), an information processing apparatus, or the like (may also be referred to not as an apparatus but as a device, a module, a unit, or the like). When performing automated driving, the traveling operation ECU 12 controls some or all of the operators 111 to 113 based on a prediction result of the prediction ECU 17.

The prediction ECU 17 has an arrangement similar to the traveling operation ECU 12, and includes a CPU 171, a memory 172, and a communication interface 173. The CPU 171 acquires peripheral information of the vehicle 1 from the detection unit 16 via the communication interface 173. The CPU 171 predicts the behavior of each object on a road based on the peripheral information, and stores the prediction result in the memory 172 or outputs it to the traveling operation ECU 12 via the communication interface 173.

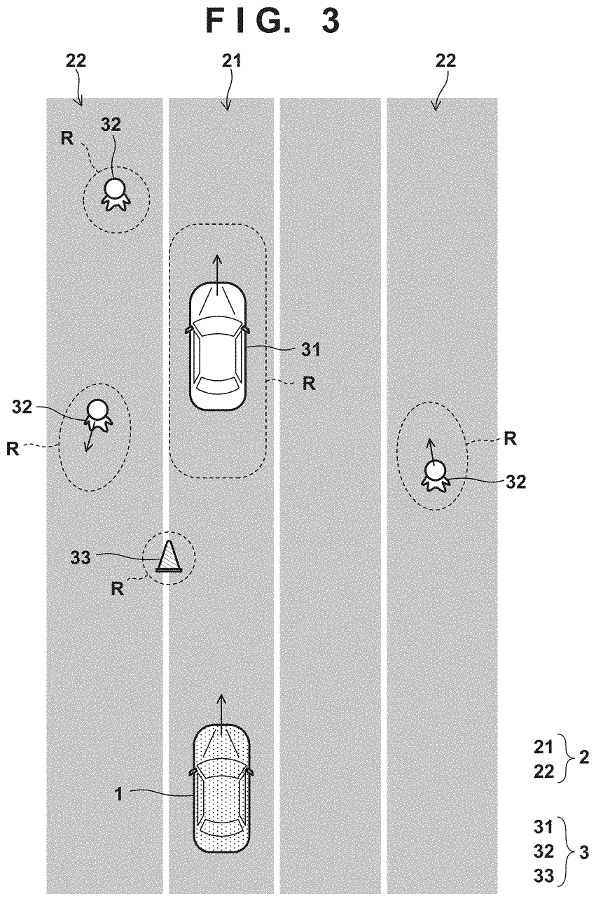

FIG. 3 is a plan view showing a state in which the vehicle 1 and a plurality of objects 3 exist on a road 2, and shows a state in which the vehicle 1 (to be referred to as a “self-vehicle 1” hereinafter for the sake of discrimination) is traveling on a roadway 21 by automated driving. The self-vehicle 1 detects the objects 3 on the roadway 21 and sidewalks 22 by the detection unit 16, and sets a traveling route so as to avoid the objects, thereby performing automated driving. Here, examples of the objects 3 are another vehicle 31, persons 32 (for example, walkers), and an obstacle 33. Note that as for each object 3 with an arrow, the arrow indicates the advancing direction of the object 3.

Note that a road cone is illustrated here as the obstacle 33. However, the obstacle 33 is not limited to this example as long as it is an object that physically interrupts traveling or an object for which avoidance of contact is recommended. The obstacle 33 may be, for example, a fallen object such as garbage, may be an installed object such as a traffic signal or a guard fence, and may be either a movable or an immovable.

As shown in FIG. 3, if the plurality of objects 3 are confirmed from the detection result (peripheral information of the vehicle 1) of the detection unit 16, the prediction ECU 17 sets a warning region R for each object 3. The warning region R is a region used to avoid contact of the self-vehicle 1, that is, a region recommended not to overlap the self-vehicle 1. The warning region R for a given object 3 is set, as a region in which the object 3 can move within a predetermined period, such that it has a predetermined width outside the outline of the object 3. The warning region R is set (changed, updated, or reset: to be simply referred to as “set” hereinafter) periodically, for example, every 10 [msec].

Note that the warning region R is represented here by a plane (two dimensions) to facilitate the explanation. In fact, the warning region R is set in accordance with a space detected by the in-vehicle detection unit 16. For this reason, the warning region R can be expressed by three-dimensional space coordinates or can be expressed by four-dimensional space coordinates including the time base.

The prediction ECU 17 sets the warning region R for, for example, the other vehicle 31 traveling in front of the self-vehicle 1 outside the outline of the other vehicle 31. The width (the distance from the outline) of the warning region R can be set based on the information of the other vehicle 31 (for example, position information such as the position relative to the self-vehicle 1 and the distance from the self-vehicle 1 and state information such as the advancing direction and the vehicle speed of the other vehicle 31, and the presence/absence of lighting of a lighting device). For example, the widths of the warning region R can be set so as to be different from each other on the front side, the lateral sides, and the rear side. For example, when the other vehicle 31 is traveling straight, the prediction ECU 17 sets the warning region R such that it has a predetermined width (for example, about 50 cm) on each lateral side of the vehicle body and a relatively large width (a width according to the vehicle speed of the other vehicle 31) on the front and rear sides of the vehicle body. When the other vehicle 31 makes a left turn (or a right turn), the prediction ECU 17 increases the width on the left side (or the right side) of the warning region R. In addition, when the other vehicle 31 stops, the warning region R may be set in the same width on the front side, the lateral sides, and the rear side.

In addition, the prediction ECU 17 sets the warning region R for, for example, the person 32 on the sidewalk 22 outside the outline of the person 32 based on the information of the person 32 (for example, position information such as the position relative to the self-vehicle 1 and the distance from the self-vehicle 1 and state information such as the moving direction, the moving speed, and the line of sight of the person 32). For example, the width of the warning region R can be set based on the information of the person 32 so as to be different from each other on the front side, the lateral sides, and the rear side. For example, the width of the warning region R is set based on the moving speed of the person 32 and/or set based on the line of sight of the person 32. When the person 32 is standing still, the warning region R may be set in the same width on the front side, the lateral sides, and the rear side.

Additionally, the prediction ECU 17 can also predict the age bracket of the person 32 and set the width of the warning region R based on the prediction result. This prediction is done using the outer appearance information (the information of the outer appearance of the person such as physique information and clothing information) of the person 32 based on the detection result from the detection unit 16.

Furthermore, the prediction ECU 17 sets the warning region R for, for example, the obstacle 33 on the roadway 21 outside the outline of the obstacle 33 based on the information of the obstacle 33 (for example, position information such as the position relative to the self-vehicle 1 and the distance from the self-vehicle 1 and state information such as the type, shape, and size). Since it is considered that the obstacle 33 does not move, the width of the warning region R may be set to a predetermined value. If the detection unit 16 further includes, for example, a wind velocity sensor and can detect a wind velocity, the width of the warning region R may be set based on the wind velocity.

The width of the warning region R for each object 3 may further be set based on the vehicle speed of the self-vehicle 1. When the self-vehicle 1 is traveling at a relatively high speed, for example, the width of the warning region R for the other vehicle 31 is set relatively large. This makes it possible to keep a sufficient distance to the other vehicle 31 and avoid contact with the other vehicle 31.

Based on the prediction result from the prediction ECU 17, the traveling operation ECU 12 sets a traveling route not to pass through the warning region R for each object 3, thereby preventing the self-vehicle 1 from coming into contact with each object 3.

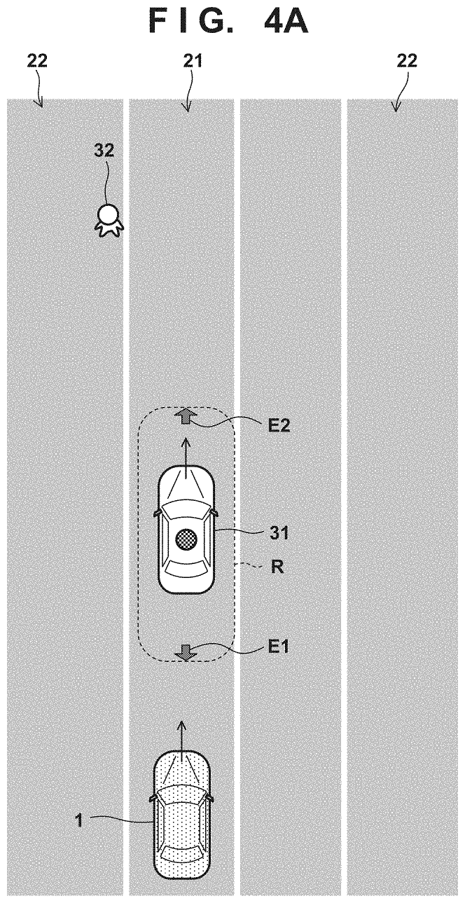

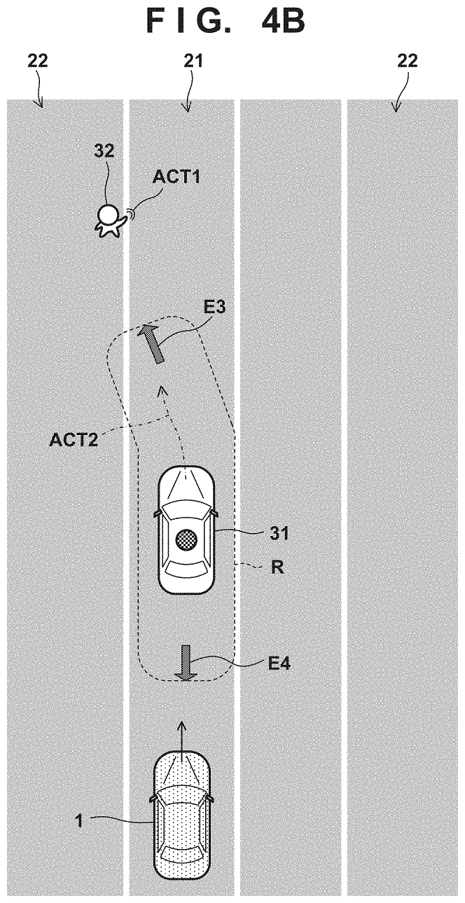

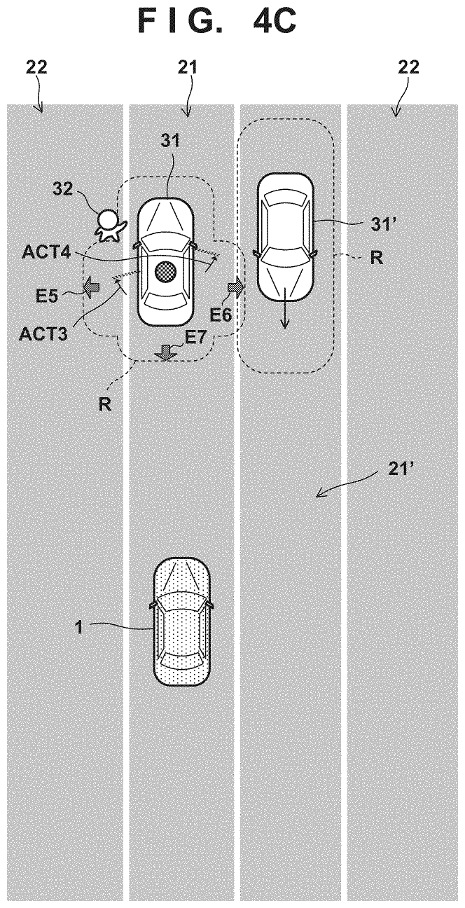

FIG. 4A is a plan view showing, as one example, a state in which the self-vehicle 1 and the other vehicle 31 are traveling along the roadway 21. The self-vehicle 1 is traveling by automated driving, and the other vehicle 31 is traveling ahead of the self-vehicle 1.

As described above (see FIG. 3), the prediction ECU 17 of the self-vehicle 1 sets the warning region R for the other vehicle 31 based on the information of the other vehicle 31. In the example of FIG. 4A, the other vehicle 31 is traveling straight at a predetermined vehicle speed, and based on this, the prediction ECU 17 sets the warning region R for the other vehicle 31.

For example, the width of the warning region R on the rear side is set in accordance with the vehicle speeds of the self-vehicle 1 and the other vehicle 31. That is, the warning region R is extended to the rear side, as indicated by an arrow E1. This makes it possible to increase or maintain the distance between the self-vehicle 1 and the other vehicle 31. Even if the other vehicle 31 decelerates or stops at an unexpected timing, it is possible to safely decelerate or stop the self-vehicle 1 and prevent the self-vehicle 1 from contacting the other vehicle 31.

Additionally, the width of the warning region R on the front side is similarly set. That is, the warning region R is extended to the front side, as indicated by an arrow E2. Note that since for the self-vehicle 1 traveling behind the other vehicle 31, the front side of the other vehicle 31 does not substantially concern, the extension of the warning region R on the front side (arrow E2) may be omitted.

Here, in this embodiment, the other vehicle 31 is assumed to be a taxi as an example of a vehicle for a pickup service. Additionally, as shown in FIG. 4A, the person 32 exists on the sidewalk 22 on the front side of the other vehicle 31. Note that although not illustrated here, the prediction ECU 17 sets the warning region R for the person 32 as well.

Here, if the person 32 raises a hand (ACT1), as shown in FIG. 4B, it is considered that the person 32 wants to ride in the other vehicle 31 that is a taxi. Hence, the other vehicle 31 traveling straight is predicted to move (ACT2) in the vehicle width direction toward the person 32 in response to the hand raise (ACT1) of the person 32. If the hand raise (ACT1) of the person 32 is detected by the detection unit 16, the prediction ECU 17 extends the warning region R to the front left side, as indicated by an arrow E3, based on the result of prediction that the other vehicle 31 moves toward the person 32.

In addition, the other vehicle 31 is predicted to decelerate while moving toward the person 32 and then stop in front of the person 32. Hence, the prediction ECU 17 extends the warning region R to the rear side, as indicated by an arrow E4, based on the result of prediction that the other vehicle 31 decelerates or stops.

Furthermore, it is predicted that after the other vehicle 31 stops in front of the person 32, a door of the other vehicle 31 on one lateral side opens to allow the person 32 to get in (In Japan, each vehicle generally travels on the left lane, it is predicted that the door on the left side opens, but the left and right may reverse depending on the country). There is also a possibility that to put the baggage of the person 32 in the trunk room, the driver of the other vehicle 31 opens a door of the other vehicle 31 on the other side (the right side in Japan) and temporarily gets off. Hence, as another embodiment, the prediction ECU 17 can predict these and extend the warning region R to a lateral side as well.

The traveling control ECU 12 can decide how to do the driving operation of the self-vehicle 1 based on the warning region R set in the above-described way. For example, the traveling control ECU 12 decides to control the self-vehicle 1 to pass the other vehicle 31 (that is sets a traveling route on a lateral side of the other vehicle 31 so as not to overlap the warning region R) or stop the self-vehicle 1 behind the other vehicle 31.

FIG. 4C is a plan view showing, as another example, a state in which another vehicle (to be referred to as an “opposite vehicle 31” for the sake of discrimination) exists on an opposite lane (to be referred to as an “opposite lane 21” for the sake of discrimination). FIG. 4C shows the warning region R for the opposite vehicle 31′ together with the opposite vehicle 31′.

In addition, FIG. 4C shows a state in which the warning region R is extended for the other vehicle 31 that has stopped in front of the person 32. In the example shown in FIG. 4C, based on the result of prediction by the prediction ECU 17 that a door of the other vehicle 31 on one lateral side (ACT3) to allow the person 32 to get in, the warning region R is extended to one lateral side, as indicted by an arrow E5. There is also a possibility that to put the baggage of the person 32 in the trunk room, the driver of the other vehicle 31 gets off the other vehicle 31. Hence, based on another result of prediction of the prediction ECU 17 that the door on the other lateral side opens (ACT4), the warning region R is extended to the other lateral side, as indicated by an arrow E6. Accordingly, the warning region R is further extended to the rear side, as indicated by an arrow E7. Here, the prediction of door opening concerning the other vehicle 31 that has stopped is performed for the door on one lateral side (see E5), the door on the other lateral side (see E6), and the trunk lid on the rear side (see E7). As another embodiment, prediction may be performed for some of these.

In this case, based on the warning regions R for the vehicles 31 and 31′ set in the above-described way, the traveling control ECU 12 determines whether the self-vehicle 1 can pass the other vehicle 31 or not, or whether the self-vehicle 1 should be stopped behind the other vehicle 31 or not. Based on the result of the determination, the traveling control ECU 12 can decide how to do the driving operation of the self-vehicle 1.

If it is confirmed based on the detection result of the detection unit 16 that the person 32 gets in the stopping other vehicle 31, the other vehicle 31 is predicted to start after that. Hence, the traveling control ECU 12 stops and waits until the other vehicle 31 starts, thereby resuming traveling at a desired vehicle speed after the start of the other vehicle 31. Note that this can be applied not only to a case in which it is confirmed that the traveling other vehicle 31 has decelerated and stopped but also to a case in which the other vehicle 31 that has already stopped is confirmed.

In the above-described examples shown in FIGS. 4A to 4C, a form in which the person 32 raises a hand is shown. However, other behavior may be exhibited as a signal of desire to get in the other vehicle 31 that is a taxi. If the person 32 exhibits a behavior to attract attention of the driver of the other vehicle 31 by, for example, waving a hand or bowing, the other vehicle 31 is predicted to decelerate while moving toward the person 32 and stop. Similar prediction is made in a case in which the person 32 exhibits a behavior that makes the driver of the other vehicle 31 expect that the person 32 is a passenger candidate (a person who desires to be a passenger) by, for example, turning their eyes to the side of the other vehicle 31 for a predetermined period.

Note that in the example shown in FIGS. 4A to 4C, the other vehicle 31 is assumed to be a taxi. However, as another embodiment, the other vehicle 31 may be a vehicle for a pickup service of another type. In Japan, examples of the vehicle for pickup services are a vehicle concerning a chauffeur service and a rickshaw in addition to a taxi. This also applies to vehicles used for pickup services in other countries. Note that the vehicles may be denoted differently from “taxi” in other countries, but are included in the concept of vehicles for pickup services (for example, a tuk-tuk in Thailand and an auto-rickshaw in India).

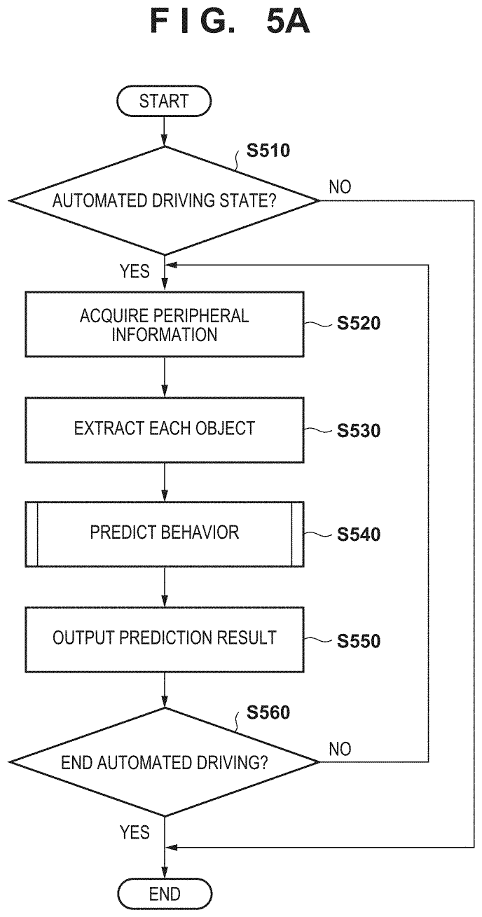

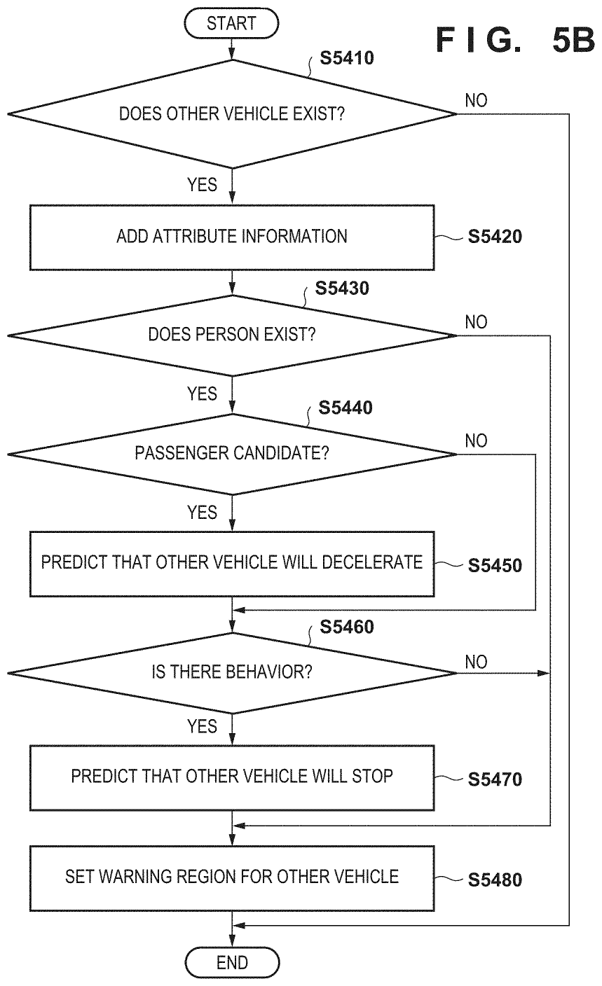

FIGS. 5A and 5B are flowcharts showing a method of performing behavior prediction of the other vehicle 31 according to this embodiment and associated setting the warning region R. The contents of these flowcharts are mainly performed by the CPU 171 in the prediction ECU 17.

If the self-vehicle 1 starts automated driving, the prediction ECU 17 recognizes each object 3 on the periphery of the self-vehicle 1 based on the peripheral information of the self-vehicle 1, sets the warning region R for each object 3, and outputs the result to the traveling control ECU 12. In such a situation, for example, if the other vehicle 31 confirmed as one of the objects 3 is a vehicle (taxi or the like) for a pickup service, the prediction ECU 17 predicts the behavior of the other vehicle 31 based on the presence/absence and behavior of the person 32 as a passenger candidate, and sets the warning region R of the other vehicle 31.

Referring to FIG. 5A, in step S510 (to be simply referred to as “S510” hereinafter, and this also applies to the other steps), it is determined whether the self-vehicle 1 is in an automated driving state. This step is performed by, for example, receiving, by the prediction ECU 17, a signal representing whether the self-vehicle 1 is in the automated driving state from the traveling control ECU 12.

If the self-vehicle is in the automated driving state, the process advances to S520. If the self-vehicle is not in the automated driving state, the flowchart is ended.

In S520, the peripheral information of the self-vehicle 1 is acquired. This step is performed by receiving, by the prediction ECU 17, the peripheral information of the self-vehicle 1 detected by the detection unit 16.

In S530, the objects 3 existing on the periphery of the self-vehicle 1 are extracted from the peripheral information obtained in S520. This step is performed by performing predetermined data processing (for example, data processing of performing outline extraction) for data representing the peripheral information.

Each object 3 is classified by the attribute (type) based on the information (the above-described position information or state information) of the object (for example, to which one of the other vehicle 31, the person 32, or the obstacle 33 each object 3 corresponds is determined). This classification can be done by, for example, pattern matching based on the outer appearance of each object 3. In addition, the warning region R can be set for each object 3. In this embodiment, the warning region R for the other vehicle 31 is set based on behavior prediction (S540) to be described later. The warning region R for the other object 3 can be set in S530.

In S540, behavior prediction of the other vehicle 31 is performed based on the information of the other vehicle 31 and the information of the other object 3, as will be described later in detail (see FIG. 5B).

In S550, a prediction result including behavior prediction in S540 is output to the traveling control ECU 12. The traveling control ECU 12 decides the traveling route of the self-vehicle 1 based on the prediction result and decides the contents of the driving operation of the self-vehicle 1.

In S560, it is determined whether to end the automated driving state of the self-vehicle 1. This step is performed by, for example, receiving, by the prediction ECU 17, a signal representing the end of the automated driving state from the traveling control ECU 12. If the automated driving state is not to be ended, the process returns to S520. If the automated driving state is to be ended, the flowchart is ended.

The series of steps S520 to S560 are repetitively performed in a period of, for example, about several tens of [msec] or in a shorter period (for example, about 10 [msec]). That is, acquisition of the peripheral information of the self-vehicle 1, detection of each object 3 on the periphery of the self-vehicle 1 and associated setting of the warning region R, and output of the results to the traveling control ECU 12 are periodically performed.

FIG. 5B is a flowchart for explaining the method of behavior prediction in S540. S540 includes S5410 to S5480, and behavior prediction of the other vehicle 31 is performed based on, for example, whether the object 31 is a vehicle for a pickup service, and the presence/absence and behavior of the person 32 as a passenger candidate. Then, the warning region R for the other vehicle 31 is set based on the prediction result.

In S5410, it is determined whether the other vehicle 31 exists among the objects 3 extracted in S530. If the other vehicle 31 exists, the process advances to S5420. Otherwise, the flowchart is ended.

In S5420, based on the attribute of the other vehicle 31 concerning the determination of S5410, attribute information representing the attribute is added to the information of the other vehicle 31. In this embodiment, the attribute information is information representing whether the other vehicle is a vehicle for a pickup service. This step is performed by, for example, pattern matching based on the outer appearance of the other vehicle 31 of the determination target or the like.

In general, whether a vehicle is a vehicle for a pickup service can easily be determined based on the outer appearance of the vehicle. Examples of the criterion of the determination are typically a number plate representing that the vehicle is a vehicle for business, an indicator light provided on the roof of the vehicle, and a color or characters added to the vehicle body. If vehicle-to-vehicle communication is possible, the attribute information can be directly received from the other vehicle 31, or a similar operation can be implemented by vehicle-to-infrastructure communication as well.

In S5430, it is determined whether the person 32 exists among the objects 3 extracted in S530. If the person 32 exists, the process advances to S5440. Otherwise, the process advances to S5480 (S5440 to 5470 are skipped).

In S5440, it is determined whether the person 32 concerning the determination of S5430 satisfies the condition of a passenger candidate. This step is performed based on the behavior of the person 32 of the determination target. Generally, on a road, a user of a pickup service like a taxi directs the face to the upstream side of the stream of vehicles and sends the gaze to find a usable taxi. Hence, if it is confirmed that the person 32 is directing the gaze toward the other vehicle 31 for a predetermined period (for example, 1 [sec] or more), the person 32 can be determined as a passenger candidate. In this case, information representing a passenger candidate can be added as attribute information to the information of the person 32. If the person 32 satisfies the condition of a passenger candidate, the process advances to S5450. Otherwise, the process advances to S5460 (S5450 is skipped).

In S5450, since it is determined in S5440 that the person 32 satisfies the condition of a passenger candidate, the other vehicle 31 may decelerate up to a position in front of the person 32, and it is therefore predicted that the other vehicle 31 decelerates.

In S5460, it is determined whether the person 32 exhibits a predetermined behavior. This step is performed based on the behavior and, in particular, the action of the person 32 of the determination target over time. Generally, a user of a pickup service like a taxi gives a signal to the driver of a vehicle for the pickup service by, for example, raising a hand several [m] to several tens [m] ahead of the vehicle for the pickup service. Hence, if the person 32 exhibits a predetermined behavior such as hand raise, the process advances to S5470. Otherwise, the process advances to S5480 (S5470 is skipped). In addition, if the person 32 exhibits a predetermined behavior, behavior information representing hand raise or the like can be added to the information of the person 32.

In S5470, since the possibility that the other vehicle 31 stops in front of the person 32 who has exhibited a predetermined behavior in S5460 becomes high, it is predicted that the other vehicle 31 stops in front of the person 32.

In S5480, the warning region R for the other vehicle 31 is set based on the prediction result representing the deceleration of the other vehicle 31 in S5450 and/or the stop of the other vehicle 31 in S5470. The warning region R may be set in a different width based on which one of the deceleration and stop of the other vehicle 31 is predicted. For example, the extension width of the warning region R on the rear side in a case in which only the deceleration of the other vehicle 31 is predicted (that is, only S5450 is performed) may be smaller as compared to another case (that is, only S5470 or both of S5450 and S5470 are performed).

Additionally, as described above, a door of the other vehicle 31 on the rear side is expected to open after the stop of the other vehicle 31. Hence, if the stop of the other vehicle 31 is expected (that is, if S5470 is performed), the warning region R for the other vehicle 31 can be extended not only to the rear side but also to the lateral side.

In the above-described way, behavior prediction of the other vehicle 31 is performed based on the information of the other vehicle 31 and the information of the object 3 (here, the person 32). After that, the warning region R for the other vehicle 31 set in the behavior prediction is output as a part of the prediction result to the traveling control ECU 12 in S550.

Note that each step of the flowchart may be changed without departing from the scope of the present invention. For example, the order of the steps may be changed, some steps may be omitted, or another step may be added. For example, if the behavior of the other vehicle 31 is predicted based on only the signal of the person 32 to the other vehicle 31, S5440 to S5450 may be omitted.

Additionally, in this embodiment, a form in which the behavior prediction of the other vehicle 31 is performed when the self-vehicle 1 is performing automated driving has been described. However, the behavior prediction may be performed even in a case in which the self-vehicle 1 is not in the automated driving state. For example, even if the driver is performing the driving operation by himself/herself, the prediction ECU 17 can perform behavior prediction of the other vehicle 31 and notify the driver of the prediction result.

As described above, according to this embodiment, the prediction ECU 17 acquires the information of the other vehicle 31 existing on the periphery of the self-vehicle 1 and the information of the other object 3 existing on the periphery of the other vehicle 31 based on the peripheral information of the self-vehicle 1 by the detection unit 16. The information of the other vehicle 31 includes, for example, attribute information representing whether the vehicle is a vehicle for a pickup service, in addition to position information such as the relative position and the distance and state information such as the advancing direction and the vehicle speed. In this embodiment the object 3 is the person 32, and the information of the person 32 includes for example, attribute information representing whether the person is a passenger candidate and behavior information representing the presence/absence of a predetermined behavior, in addition to position information such as the relative position and the distance and state information such as the moving direction, the moving speed, the posture, and the line of sight. The prediction ECU 17 predicts the behavior of the other vehicle 31 based on the information of the other vehicle 31 and the information of the other object 3. According to this embodiment, the prediction ECU 17 predicts the behavior of the other vehicle 31 in consideration of the influence of the object 3 on the other vehicle 31. It is therefore possible to raise the accuracy of behavior prediction of the other vehicle 31 as compared to a case in which the prediction is performed by placing focus only on the other vehicle 31.

### Second Embodiment

In the above-described first embodiment, a form of a case in which the person 32 is confirmed as the object 3, and the person 32 exhibits a certain behavior (for example, raises a hand) has been described. In the second embodiment, even in a case in which the behavior of a person 32 is not confirmed, if another vehicle 31 exhibits a predetermined behavior, a prediction ECU 17 predicts deceleration or stop of the other vehicle 31. After that, the prediction ECU 17 sets a warning region R for the other vehicle 31 based on the result of the prediction, as described above (see the first embodiment).

Note that the case in which the behavior of the person 32 is not confirmed is a case in which the behavior of the person 32 is not detected by a detection unit 16, and it does not matter whether the behavior is actually exhibited by the person 32.

For example, if it is confirmed that the other vehicle 31 traveling on a roadway 21 moves toward the person 32 in the vehicle width direction (toward a sidewalk 22), there is a possibility that the other vehicle 31 stops to allow the person 32 to get in. Hence, the prediction ECU 17 predicts deceleration or stop of the other vehicle 31.

In general, a person gets in a temporarily stopped vehicle in a place where a partition member that partitions a roadway and a sidewalk, for example, a guard fence (guardrail or the like), curbstone, shrubbery, or the like is not arranged. Hence, if the detection unit 16 detects the person 32 in a place where the partition member is not arranged (for example, a gap between the partition members), the prediction ECU 17 may perform the prediction using this as one of the conditions.

As described above, according to this embodiment as well, the prediction ECU 17 can predict that the other vehicle 31 decelerates up to a position in front of the person 32, or the other vehicle 31 stops in front of the person 32, and can accurately predict the behavior of the other vehicle 31. Additionally, according to this embodiment, even if the behavior of the person 32 is not confirmed, the behavior of the other vehicle 31 can be predicted. It is therefore possible to predict the behavior of the other vehicle 31 even in a case in which the other vehicle 31 is not a vehicle for a pickup service (for example, in a case in which a parent drives the other vehicle 31 to pick up a child coming home).

### Third Embodiment

In the above-described first embodiment, if the other vehicle 31 stops, a door of the other vehicle 31 on a lateral side may open. Hence, the warning region R for the other vehicle 31 is extended to the lateral side. However, as the third embodiment, if a predetermined condition is satisfied, the extension of a warning region R may be omitted.

For example, in a case in which another object (a pedestrian, an obstacle, or the like) is confirmed on the advancing route of another vehicle 31 (including a temporary case, for example, a case in which entry of another object into the advancing route of the other vehicle 31 is confirmed), getting in/out of a person 32 may not be performed even if the other vehicle 31 stops. In addition, even in a case in which it is confirmed that a traffic signal ahead of the other vehicle 31 is showing red light or a case in which a crosswalk exists ahead of the other vehicle 31, getting in/out of the person 32 may not be performed. Hence, in these cases, a prediction ECU 17 predicts that a door does not open even if the other vehicle 31 stops. This can be implemented by acquiring, by the prediction ECU 17, the front information of the other vehicle 31.

The front information of the other vehicle 31 includes, for example, information representing the presence/absence of an object 3 ahead of the other vehicle 31, information representing a traveling environment based on it (whether the situation allows traveling), and the like. The front information of the other vehicle 31 may be acquired as part of the peripheral information of a self-vehicle 1 (can be acquired as one of detection results of a detection unit 16), or may be acquired by vehicle-to-vehicle communication or road-to-vehicle communication.

Additionally, even in a case in which an obstacle 33 is confirmed ahead of the other vehicle 31 based on the front information, the prediction ECU 17 can predict the behavior of the other vehicle 31. For example, it is predicted that the other vehicle 31 decelerates and stops in front of the obstacle 33, or it is predicted that the other vehicle 31 changes the lane or temporarily enters the opposite lane to avoid the obstacle 33. Hence, if the obstacle 33 is confirmed ahead of the other vehicle 31, the prediction ECU 17 can set a warning region R for the other vehicle 31 based on the result of prediction.

### Fourth Embodiment

In the above-described first embodiment, a case in which the other vehicle 31 is traveling in the same direction as the self-vehicle 1 has been described. As the fourth embodiment, a case in which another vehicle 31 is an opposite vehicle for a self-vehicle 1 will be described below.

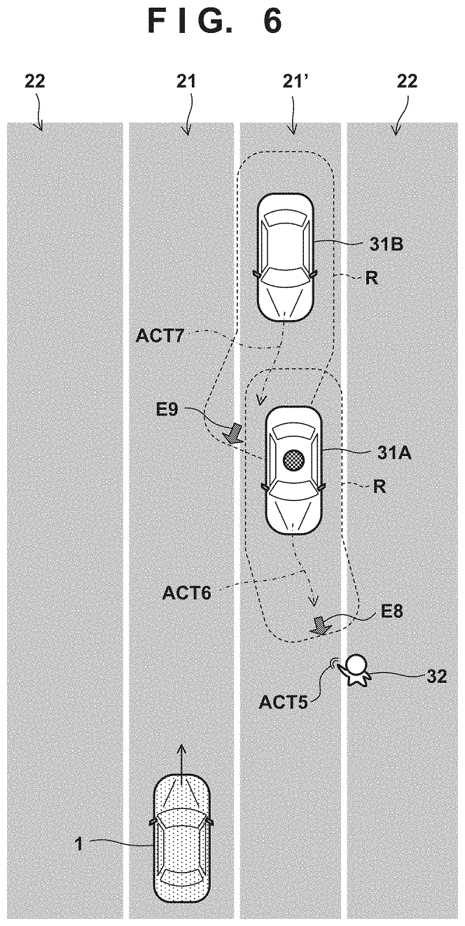

FIG. 6 is a plan view showing a state in which the self-vehicle 1 is traveling by automated driving on a lane 21, and two other vehicles (to be referred to as an “opposite vehicle 31A” and an “opposite vehicle 31B” for the sake of discrimination) are traveling on an opposite lane 21′. The opposite vehicle 31A is traveling on an opposite lane 21′ ahead of the self-vehicle 1, and the opposite vehicle 31B is traveling behind the opposite vehicle 31A. That is, the opposite vehicle 31A is located closer to the self-vehicle 1 than the opposite vehicle 31B. In this embodiment, the opposite vehicle 31A is assumed to be a taxi. In addition, a person 32 exists ahead of the opposite vehicle 31A.

For example, if the person 32 raises a hand (ACT5), it is predicted that the opposite vehicle 31A decelerates while moving toward the person 32 in response to that, and stops in front of the person 32 (ACT6). Hence, based on the result of the prediction, a prediction ECU 17 extends a warning region R for the opposite vehicle 31A to the front left side of the opposite vehicle 31A, as indicated by an arrow E8. This is similar to the first embodiment (see FIG. 4B) except that the behavior prediction target is the opposite vehicle.

On the other hand, the opposite vehicle 31B traveling behind the opposite vehicle 31A passes the opposite vehicle 31A accordingly, and may temporarily enter the self-lane 21 (ACT7). The prediction ECU 17 predicts this, thereby extending the warning region R for the opposite vehicle 31B to the front right side of the opposite vehicle 31B, as indicated by an arrow E9. This can avoid contact of the self-vehicle 1 with the opposite vehicle 31B.

According to this embodiment, the prediction ECU 17 can predict the behavior (ACT6) of the opposite vehicle 31A based on the behavior (ACT5) of the person 32, and can further predict the behavior (ACT7) even for the following opposite vehicle 31B based on the prediction. In other words, the prediction ECU 17 performs behavior prediction for the opposite vehicle 31A/31B in consideration of a direct/indirect influence concerning the behavior of the person 32. This also applies not only to a case in which only the above-described two opposite vehicles 31A and 31B exist but also to a case in which three or more opposite vehicles (other vehicles) exist.

Hence, according to this embodiment, the prediction ECU 17 can accurately perform behavior prediction of the plurality of other vehicles 31 (here, the opposite vehicles 31A and 31B), and set the appropriate warning regions R for the other vehicles 31 based on the prediction results.

### Other Embodiments

Several preferred embodiments have been described above. However, the present invention is not limited to these examples and may partially be modified without departing from the scope of the invention. For example, another element may be combined with the contents of each embodiment in accordance with the object, application purpose, and the like. Part of the contents of a certain embodiment may be combined with the contents of another embodiment. In addition, individual terms described in this specification are merely used for the purpose of explaining the present invention, and the present invention is not limited to the strict meanings of the terms and can also incorporate their equivalents.

Furthermore, a program that implements at least one function described in each embodiment is supplied to a system or an apparatus via a network or a storage medium, and at least one processor in the computer of the system or the apparatus can read out and execute the program. The present invention can be implemented by this form as well.

### Summary of Embodiments

The first aspect concerns a prediction apparatus (for example, 17), and the prediction apparatus comprises acquisition means (for example, 171, S520) for acquiring information of another vehicle (for example, 31) existing on the periphery of a self-vehicle (for example, 1) and information of an object (for example, 3) existing on the periphery of the other vehicle, and prediction means (for example, 171, S540) for predicting a behavior of the other vehicle based on the information of the other vehicle and the information of the object acquired by the acquisition means.

According to the first aspect, for example, on a road, the behavior of the other vehicle is predicted in consideration of the influence of the object on the other vehicle. Hence, according to the first aspect, it is therefore possible to raise the accuracy of behavior prediction of the other vehicle as compared to a case in which the prediction is performed by placing focus only on the other vehicle.

In the second aspect, the prediction means predicts the behavior of the other vehicle based on a behavior of a person (for example, 32) as the object.

According to the second aspect, if the person confirmed as the object exhibits a certain behavior, there is a possibility that a predetermined relationship exists between the person and the other vehicle. Hence, the behavior of the other vehicle is predicted in response to the behavior of the person. Hence, according to the second aspect, it is possible to more accurately predict the behavior of the other vehicle.

In the third aspect, if a person (for example, 32) is confirmed as the object, and it is confirmed that the other vehicle moves to a side of the person, the prediction means predicts that the other vehicle stops.

According to the third aspect, if the other vehicle moves to the side of the person confirmed as the object, there is a possibility that a predetermined relationship exists between the person and the other vehicle. Hence, the behavior of the other vehicle is predicted in response to the movement of the other vehicle to the side of the person. Hence, according to the third aspect, it is possible to more accurately predict the behavior of the other vehicle.

In the fourth aspect, if a person (for example, 32) is confirmed as the object, and it is confirmed that the person raises a hand (for example, S5460), the prediction means predicts that the other vehicle will stop in front of the person.

According to the fourth aspect, if the person raises the hand, there is a possibility that a predetermined relationship exists between the person and the other vehicle. It is therefore predicted that the other vehicle will stop in front of the person. Hence, according to the fourth aspect, it is possible to more accurately predict the behavior of the other vehicle.

In the fifth aspect, if a person (for example, 32) is confirmed as the object, and it is confirmed that the person turns eyes to a side of the other vehicle (for example, S5440), the prediction means predicts that the other vehicle will decelerate.

According to the fifth aspect, if the person turns eyes to the other vehicle, there is a possibility that a predetermined relationship exists between the person and the other vehicle. Hence, deceleration of the other vehicle is predicted in response to the turning of the eyes of the person to the other vehicle. Hence, according to the fifth aspect, it is possible to more accurately predict the behavior of the other vehicle.

In the sixth aspect, if a person (for example, 32) is confirmed as the object, the prediction means predicts that a door of the other vehicle will open in front of the person (for example, E5 E7).

According to the sixth aspect, for example, in a case of passing the other vehicle, it can be decided to set a relatively long distance between the self-vehicle and a lateral side of the other vehicle, or it can be decided to stop the self-vehicle behind the other vehicle.

In the seventh aspect, if a person (for example, 32) is confirmed as the object, and it is confirmed that the person got in a stopped other vehicle, the prediction means predicts that the other vehicle will start.

According to the seventh aspect, it is possible to more accurately predict the behavior of the stopped other vehicle.

In the eighth aspect, the acquisition means further acquires front information of the other vehicle, and if the front information satisfies a predetermined condition, the prediction means predicts that the door of the other vehicle will not open even if the other vehicle stops.

According to the eighth aspect, the presence/absence of opening/closing of the door of the stopped other vehicle is predicted based on the front information of the other vehicle. The reason of the stop of a vehicle is often associated with the front information of the vehicle (for example, a walker exists in front of the vehicle). For this reason, when the front information of the other vehicle is further acquired, and the state ahead of the other vehicle is estimated, the behavior of the stopped other vehicle can more accurately be predicted.

In the ninth aspect, the predetermined condition includes that an object exists on a traveling route of the other vehicle and/or that a traffic signal ahead of the other vehicle is showing red light.

According to the ninth aspect, after the reason of the stop of the other vehicle is solved, the possibility that the other vehicle starts becomes high. It is therefore possible to more accurately predict the behavior of the stopped other vehicle.

In the 10th aspect, the prediction means further predicts the behavior of the other vehicle based on whether the other vehicle is a vehicle for a pickup service (for example, S5420).

According to the 10th aspect, if the other vehicle is a vehicle (for example, a taxi) for a pickup service, the prediction described above is performed. The vehicle for the pickup service often changes its behavior based on the behavior of the person on the road. Hence, the 10th aspect is suitable to accurately predict the behavior of the vehicle for the pickup service.

In the 11th aspect, the prediction apparatus further comprises setting means (for example, S5480) for setting a warning region (for example, R) for the other vehicle based on a result of the prediction by the prediction means.

According to the 11th aspect, the warning region for the other vehicle is set based on the result of prediction in each of the above-described aspects. This makes it possible to perform driving while increasing or ensuring the distance to the other vehicle and implement safe driving.

The 12th aspect concerns a vehicle (for example, 1), and the vehicle comprises detection means (for example, 16) for detecting another vehicle (for example, 31) existing on the periphery of a self-vehicle and an object (for example, 3) existing on the periphery of the other vehicle, and prediction means (for example, 17) for predicting a behavior of the other vehicle based on a detection result of the other vehicle and a detection result of the object by the detection means.

According to the 12th aspect, since the behavior of the other vehicle is predicted based on the information of the object on the periphery of the other vehicle, as in the first aspect, the prediction can accurately be performed.

The 13th aspect concerns a prediction method, and the prediction method comprises a step (for example, S520) of acquiring information of another vehicle (for example, 31) existing on the periphery of a self-vehicle (for example, 1) and information of an object (for example, 3) existing on the periphery of the other vehicle, and a step (for example, S540) of predicting a behavior of the other vehicle based on the information of the other vehicle and the information of the object acquired in the step of acquiring.

According to the 13th aspect, since the behavior of the other vehicle is predicted based on the information of the object on the periphery of the other vehicle, as in the first aspect, the prediction can accurately be performed.

The 14th aspect is a program configured to cause a computer to execute each step described above.

According to the 14th aspect, the prediction method according to the 13th aspect can be implemented by the computer.

The present invention is not limited to the above embodiments, and various changes and modifications can be made within the spirit and scope of the present invention. Therefore, to apprise the public of the scope of the present invention, the following claims are made.

### REFERENCE SIGNS LIST

1: self-vehicle, 3: object, 31: another vehicle, 32: person, 17: prediction ECU (in-vehicle prediction apparatus).

1. A prediction apparatus comprising:
an acquisition unit for acquiring information of another vehicle existing on the periphery of a self-vehicle and information of an object existing on the periphery of the other vehicle; and
a prediction unit for predicting a behavior of the other vehicle based on the information of the other vehicle and the information of the object acquired by the acquisition unit,
wherein if a person is confirmed as the object, and it is confirmed that the person turns eyes to a side of the other vehicle, the prediction unit predicts that the other vehicle will decelerate.

2. A prediction apparatus comprising:
an acquisition unit for acquiring information of another vehicle existing on the periphery of a self-vehicle and information of an object existing on the periphery of the other vehicle; and
a prediction unit for predicting a behavior of the other vehicle based on the information of the other vehicle and the information of the object acquired by the acquisition unit,
wherein the acquisition unit further acquires front information of the other vehicle, and
if the front information satisfies a predetermined condition, the prediction unit predicts that, getting in/out of a person will not be performed for the other vehicle even if the other vehicle stops.

3. The prediction apparatus according to claim 2, wherein the predetermined condition includes that an object exists on a traveling route of the other vehicle and/or that a traffic signal ahead of the other vehicle is showing red light.

4. A vehicle comprising:
a detection unit for detecting another vehicle existing on the periphery of a self-vehicle and an object existing on the periphery of the other vehicle; and
a prediction unit for predicting a behavior of the other vehicle based on a detection result of the other vehicle and a detection result of the object by the detection unit,
wherein, letting the other vehicle be a first other vehicle, in a case that a second other vehicle is traveling behind the first other vehicle, the prediction unit predicts that the first other vehicle will stop based on a behavior of a person as the object, and that the second other vehicle will pass the first other vehicle.

5. A computer-readable storage medium storing a program, the program configured to cause a computer to function as each unit of the vehicle according to claim 4.
